(19) United States
(12) Patent Application Publication
(10) Pub. No.: US 2026/0094482 A1
(43) Pub. Date: Apr. 2, 2026

(54) ACCESS CONTROL METHOD, SYSTEM, RELATED APPARATUS, AND ENERGY STORAGE SYSTEM

(71) Applicant: Eve Energy Storage Co., Ltd., Wuhan (CN)

(72) Inventors: Jian XIANG, Wuhan (CN); Zihui ZHAO, Wuhan (CN); Haohao YI, Wuhan (CN)

(73) Assignee: Eve Energy Storage Co., Ltd., Wuhan (CN)

(21) Appl. No.: 19/340,773

(22) Filed: Sep. 25, 2025

(30) Foreign Application Priority Data
Sep. 30, 2024 (CN) 202411392953.7
Dec. 2, 2024 (WO) PCT/CN2024/136110

(51) Int. Cl. G07C 9/27; G07C 9/00; G08B 17/06

(52) U.S. Cl. CPC G07C 9/27; G07C 9/00896; G08B 17/06

(57) ABSTRACT

The application provides an access control method, system, related apparatus, and energy storage system. The access control system includes a switch control module and an access control module connected to each other; the access control module is configured to acquire fire protection data within the energy storage system and operational data of the energy storage module, determine a target access control mode of the access control system based on the acquired data, and determine an access control instruction for the switch control module based on the target access control mode.

### CROSS-REFERENCE TO RELATED APPLICATION

The present application claims priority to International Application No. PCT/CN2024/136110 filed with the China National Intellectual Property Administration (CNIPA) on Dec. 2, 2024 and priority to Chinese patent application No. 202411392953.7 filed with the CNIPA on Sep. 30, 2024, the entire contents of which are incorporated herein by reference.

### TECHNICAL FIELD

The present application relates to a field of energy storage technology, specifically to an access control method, system, related apparatus, and energy storage system.

### BACKGROUND

An energy storage system is an apparatus capable of storing and releasing energy, widely used in power systems, new energy generation, and renewable energy utilization.

However, energy storage systems are generally deployed in containers and placed outdoors, which poses certain safety risks.

### SUMMARY

In a first aspect, the present application provides an access control system applied to an energy storage system, wherein the energy storage system includes a container, a container door disposed on the container, an energy storage module disposed within the container, and the access control system;

wherein the access control system includes a switch control module and an access control module, and the access control module is connected to the switch control module; and

the access control module is configured to acquire fire protection data within the energy storage system and operational data of the energy storage module, determine a target access control mode of the access control system based on the fire protection data and the operational data, and determine an access control instruction for the switch control module based on the target access control mode, so as to control opening and/or closing of the container door through the switch control module based on the access control instruction.

In a second aspect, the present application further provides an energy storage system, wherein the energy storage system includes a container, a container door disposed on the container, an energy storage module disposed within the container, a battery management system, a fire protection system, and an access control system;

the access control system includes a switch control module and an access control module, the access control module is connected to the switch control module, the battery management system, and the fire protection system, the switch control module is disposed on the container door, and the battery management system is connected to the energy storage module;

the fire protection system is configured to acquire fire protection data and send the fire protection data to the access control module;

the battery management system is configured to acquire operational data of the energy storage module and send the operational data to the access control module; and

the access control module is configured to determine a target access control mode of the access control system based on the fire protection data and the operational data, and determine an access control instruction for the switch control module based on the target access control mode, so as to control opening and/or closing of the container door through the switch control module based on the access control instruction.

In a third aspect, the present application further provides an access control method, wherein the energy storage system includes a container, a container door disposed on the container, an energy storage module disposed within the container, and an access control system; wherein the access control system includes a switch control module and an access control module, and the access control module is connected to the switch control module;
the method includes:
acquiring fire protection data within the energy storage system and operational data of the energy storage module;
determining a target access control mode of the access control system based on the fire protection data and the operational data; and
determining an access control instruction for the switch control module based on the target access control mode, so as to control opening and/or closing of the container door through the switch control module based on the access control instruction.

In a fourth aspect, the present application further provides a computer-readable storage medium having a computer program stored thereon, and the computer program is loaded by a processor to execute the steps of the access control method.

### BRIEF DESCRIPTION OF THE DRAWINGS

FIG. 1 is a schematic structural diagram of an access control system provided by a possible implementation of the present application;

FIG. 2 is a schematic structural diagram of an energy storage system provided by a possible implementation of the present application;

FIG. 3 is a schematic structural diagram of a fire protection system provided by a possible implementation of the present application;

FIG. 4 is a schematic flowchart of an access control method provided by a possible implementation of the present application; and

FIG. 5 is a schematic structural diagram of an access control module provided by a possible implementation of the present application.

### DETAILED DESCRIPTION

With the upgrading and transformation of the power industry, containerized and outdoor cabinet-type energy storage systems are becoming increasingly prevalent. The main structural form of energy storage containers or outdoor cabinets is a container or cabinet body. An energy storage system generally includes components such as an energy storage module, a battery management system, a battery thermal management system, and a fire protection system. However, most current energy storage systems are not equipped with an access control system, which poses certain safety risks. Additionally, maintenance operators of energy storage systems should possess strong professional expertise, and unauthorized personnel should not be allowed to arbitrarily open the container or cabinet door for operation. Moreover, most door-opening designs are not linked with other systems. To address this, the embodiments of the present application provide an access control method, system, related apparatus, and energy storage system, which acquire fire protection data sent by the fire protection system and operational data of the energy storage module sent by the battery management system through the access control module in the access control system, determine a target access control mode of the access control system based on the fire protection data and the operational data, and determine an access control instruction for the switch control module based on the target access control mode, so as to control the opening and/or closing of the container door through the switch control module based on the access control instruction. This enables the access control system to interoperate with the energy storage module and fire protection system of the energy storage system, allowing the access control system to set corresponding access control modes based on the fire protection and operational conditions of the energy storage system, thereby reducing safety risks of the energy storage system and improving safety of the energy storage system. The specific scheme is described in detail below.

It should be noted that, in the following text, the terms “battery module,” “battery,” “battery element,” “cell,” and “battery pack” may be used interchangeably and may refer to any of various rechargeable battery chemistries and configurations, including but not limited to lithium-ion (e.g., lithium iron phosphate, lithium cobalt oxide, other lithium metal oxides, etc.), lithium-ion polymer, nickel-metal hydride, nickel-cadmium, nickel-hydrogen, nickel-zinc, silver-zinc, or other battery types/configurations.

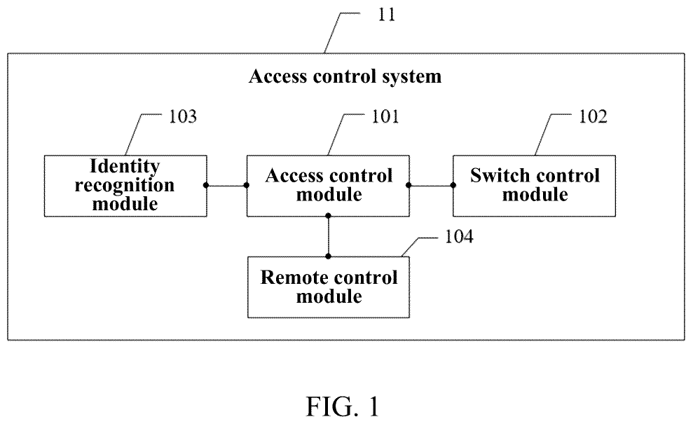

Specifically, referring to FIG. 1, the access control system 11 can be applied to the energy storage system 10. The energy storage system 10 may include a container, a container door disposed on the container, an energy storage module 14 disposed within the container, (a battery management system 13, a fire protection system 12), and the access control system 11. Specifically, the access control system 11 may include a switch control module 102 and an access control module 101, and the access control module 101 is connected to the switch control module 102; the access control module 101 is configured to acquire fire protection data within the energy storage system 10 and operational data of the energy storage module 14, determine a target access control mode of the access control system 11 based on the fire protection data and the operational data, and determine an access control instruction for the switch control module 102 based on the target access control mode, so as to control the opening and/or closing of the container door through the switch control module 102 based on the access control instruction.

The container of the energy storage system 10 may be a containerized or cabinet type. The energy storage module 14 may include multiple battery clusters, each of which may be configured with a corresponding battery management system 13, or a single battery management system 13 may be configured to manage all battery clusters.

The access control system 11 is an electronic automation system used to manage and control the entry and exit passages of a target object. A primary function of the access control system 11 is to restrict and manage the access rights of personnel or items through various technical means to ensure the safety of the premises, where the target object may include buildings, structures, etc.

In some embodiments, the access control module 101 is configured to acquire fire protection data sent by the fire protection system 12 and operational data of the energy storage module 14 sent by the battery management system 13, determine a target access control mode of the access control system 11, and determine an access control instruction for the switch control module 102 based on the target access control mode, so as to control the opening and/or closing of the container door through the switch control module 102 based on the access control instruction.

In the embodiments of the present application, the access control module 101 in the access control system 11 acquires fire protection data sent by the fire protection system 12 and operational data of the energy storage module 14 sent by the battery management system 13, determines a target access control mode of the access control system 11 based on the fire protection data and the operational data, and determines an access control instruction for the switch control module 102 based on the target access control mode, so as to control the opening and/or closing of the container door through the switch control module 102 based on the access control instruction. This enables the access control system 11 to interoperate with the energy storage module 14 and fire protection system 12 of the energy storage system 10, allowing the access control system 11 to set corresponding access control modes based on the fire protection and operational conditions of the energy storage system 10, thereby reducing safety risks of the energy storage system 10 and improving safety of the energy storage system 10.

In one embodiment, the access control system 11 further includes an identity recognition module 103, and the identity recognition module 103 is connected to the access control module 101;

the identity recognition module 103 is configured to collect and identify user identity information and send the user identity information to the access control module 101;

the access control module 101 is configured to determine a target access permission of the user based on the user identity information and a preset mapping relationship between user identity information and access permissions, and determine an access control instruction for the switch control module 102 based on the target access permission and the target access control mode, so as to control the opening and/or closing of the container door through the switch control module 102 based on the access control instruction.

The identity recognition module 103 may include at least one of magnetic card recognition, facial recognition, fingerprint recognition, and iris recognition modules.

For example, the access control system 11 may include only a facial recognition module or a magnetic card recognition module, or it may include both facial recognition and fingerprint recognition modules, or both magnetic card recognition and facial recognition modules. The specific configuration can be selected based on actual needs and is not limited herein.

In one embodiment, the mapping relationship between user identity information and access permissions may be preset, wherein the mapping relationship can be set and modified by personnel with corresponding authority and stored in a preset target storage object, which is not limited and can be selected based on actual needs.

In the embodiments of the present application, by providing the identity recognition module 103 in the access control system 11, the identity information of personnel needing to enter the energy storage system 10 can be effectively and accurately identified, and matched and compared with the preset mapping relationship between user identity information and access permissions to ensure whether the personnel have the corresponding access rights. This can effectively prevent unauthorized personnel from entering, avoid property losses, reduce safety risks, and further improve the management efficiency and safety of the energy storage system 10.

In one embodiment, the access control modes include a non-locked mode and a locked mode, the fire protection data include normal fire protection feedback data and abnormal fire protection feedback data, and the operational data include a normal operating state and a stopped operating state.

Determining the target access control mode of the access control system 11 based on the fire protection data and the operational data includes:
if the fire protection data are normal fire protection feedback data and the operational data indicate a stopped operating state, determining the access control mode as the non-locked mode;
if the fire protection data are abnormal fire protection feedback data and/or the operational data indicate a normal operating state, determining the access control mode as the locked mode.

The non-locked mode is an access control mode that allows entry, meaning the system determines that no safety risks are inside the container of the energy storage system 10, thus allowing personnel with access permissions to enter. The locked mode is an access control mode that prohibits entry, meaning the system determines that safety risks are inside the container of the energy storage system 10, thus prohibiting anyone from entering. Specifically, the non-locked mode may include at least one of an administrator mode, a debugging mode, and a visitor mode. The locked mode may include a normal operating mode of the energy storage system 10 and an emergency mode (in the presence of a fire warning or fire alarm).

In a specific embodiment, the access control strategies for various modes are as the follow table:

| | Access Control | |
|---|---|---|
| Type | Mode | Access Control Strategy |
| Non- | Administrator | The administrator has the highest authority and can control the |
| locked | Mode | opening and closing of the container door remotely or on-site. In |
| Mode | | this mode, the access permissions of other members are revoked. |
| | Debugging | The administrator can authorize debugging personnel as system |
| | Mode | maintainers or visitors. Authorized personnel can open and close |
| | | the container door on-site after identity verification. |
| | Visitor Mode | In this mode, the administrator authorizes external personnel as |
| | | visitors. When visitors need to open the container door to view |
| | | the system, a system maintainer must confirm that the system is |
| | | not in an energized operating state, and both the visitor and the |
| | | maintainer must verify their identity information before the |
| | | container door can be opened or closed. |
| Locked | Emergency | The access control system 11 interlocks with the internal |
| Mode | Mode | monitoring system and fire detection system of the energy |
| | | storage system 10. When a danger is detected inside the system, |
| | | the system automatically enters emergency mode. In this mode, |
| | | the external alarm system is activated to prompt external |
| | | personnel to evacuate, while the container door remains closed, |
| | | and no member can open or close the container door until the |
| | | internal danger is resolved and the system returns to normal |
| | | operating mode. |
| | Normal | In this mode, the system is in an energized operating state, and |
| | Operating Mode | no identity can remotely control the closing or opening of the |
| | | container door. The container door can only be opened or closed |
| | | by a system administrator or system maintainer on-site after |
| | | confirming that the system is in a non-operating mode. The |
| | | container door cannot be opened while the system is in operating |
| | | mode. |

In the embodiments of the present application, by dividing the access control modes into multiple different modes, the system is applicable to various application scenarios, improving the precision of access control system 11 management.

In one embodiment, determining the access control instruction for the switch control module 102 based on the target access permission and the target access control mode, so as to control the opening and/or closing of the container door through the switch control module 102 based on the access control instruction, includes:
if the target access control mode is the non-locked mode and the target access permission meets a preset access permission requirement, generating an access control instruction and sending the access control instruction to the switch control module 102 to control the opening of the container door through the switch control module 102;
if the target access control mode is the locked mode and user identity information is acquired, generating a non-openable feedback message and sending the non-openable feedback message to a preset target terminal.

The target terminal may be a voice feedback apparatus installed on the energy storage system 10 or a mobile terminal apparatus such as a user's mobile phone (specifically, feedback can be provided based on a phone number pre-bound to the user's identity information).

In some embodiments of the present application, by identifying and judging the normal fire protection feedback data and abnormal fire protection feedback data included in the fire protection data, as well as the normal operating state and stopped operating state included in the operational data, the system determines whether no safety risks are inside the container of the energy storage system 10, allowing personnel with access permissions to enter, or determines that safety risks are inside the container, prohibiting anyone from entering. This enhances the close coordination between the access control system 11 and the energy storage system 10, improving the safety of the energy storage system 10.

In one embodiment, the access control system 11 further includes a remote control module 104, and the remote control module 104 is connected to the access control module 101;
the remote control module 104 is configured to receive remote control information sent by a user terminal and send the remote control information to the access control module 101 to remotely control the switch control module 102.

In the embodiments of the present application, by providing the remote control module 104 in the access control system 11, the access control system 11 can receive remote control information sent by a user terminal through the remote control module 104 and send the remote control information to the access control module 101 to remotely control the switch control module 102, effectively improving the usability of the access control system 11.

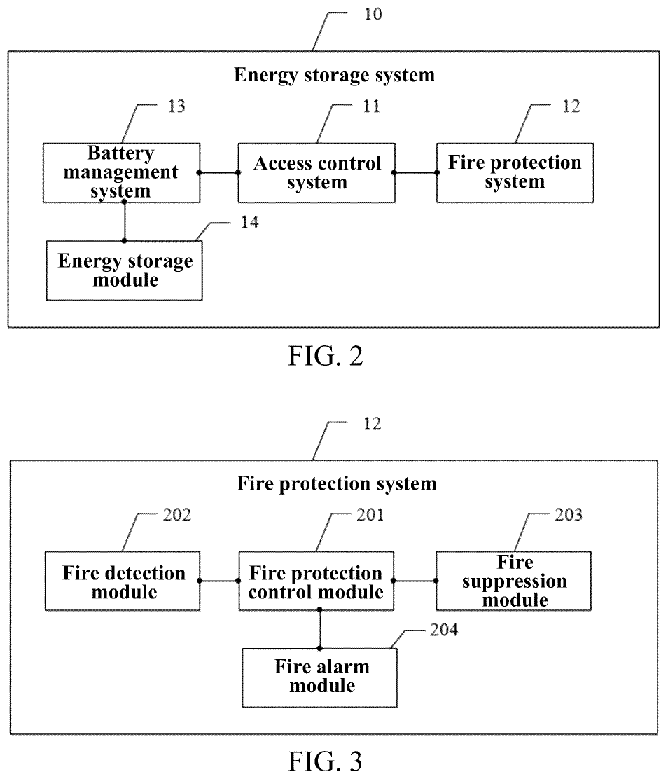

Based on the same inventive concept, the present application further provides an energy storage system 10. Referring to FIG. 2, the energy storage system 10 includes a container, a container door disposed on the container, an energy storage module 14 disposed within the container, a battery management system 13, a fire protection system 12, and an access control system 11;
wherein the access control system 11 includes a switch control module 102 and an access control module 101, the access control module 101 is connected to the switch control module 102, the battery management system 13, and the fire protection system 12, the switch control module 102 is disposed on the container door, and the battery management system 13 is connected to the energy storage module 14;
the fire protection system 12 is configured to acquire fire protection data and send the fire protection data to the access control module 101;
the battery management system 13 is configured to acquire operational data of the energy storage module 14 and send the operational data to the access control module 101;
the access control module 101 is configured to determine a target access control mode of the access control system 11 based on the fire protection data and the operational data, and determine an access control instruction for the switch control module 102 based on the target access control mode, so as to control the opening and/or closing of the container door through the switch control module 102 based on the access control instruction.

In the embodiments of the present application, the access control module 101 in the access control system 11 acquires fire protection data sent by the fire protection system 12 and operational data of the energy storage module 14 sent by the battery management system 13, determines a target access control mode of the access control system 11 based on the fire protection data and the operational data, and determines an access control instruction for the switch control module 102 based on the target access control mode, so as to control the opening and/or closing of the container door through the switch control module 102 based on the access control instruction. This enables the access control system 11 to interoperate with the energy storage module 14 and fire protection system 12 of the energy storage system 10, allowing the access control system 11 to set corresponding access control modes based on the fire protection and operational conditions of the energy storage system 10, thereby reducing safety risks of the energy storage system 10 and improving safety of the energy storage system 10.

In one embodiment, referring to FIG. 3, the fire protection system 12 includes a fire protection control module 201, a fire detection module 202, a fire suppression module 203, and a fire alarm module 204, and the fire protection control module 201 is connected to the fire detection module 202, the fire suppression module 203, the fire alarm module 204, and the access control module 101;
the fire detection module 202 is configured to collect fire detection data of the energy storage system 10 and send the fire detection data to the fire protection control module 201;
the battery management system 13 is further configured to collect battery monitoring data of the energy storage module and send the battery monitoring data to the fire protection control module 201, the battery monitoring data including voltage monitoring data and temperature monitoring data of each cell in the energy storage module;
the fire protection control module 201 is configured to determine the fire protection data based on the fire detection data and the battery monitoring data, send the fire protection data to the access control module 101, and control the fire suppression module 203 to execute a corresponding fire suppression strategy based on the fire protection data.

In one embodiment, the fire detection module 202 includes at least one of an intelligent fire monitoring camera, a combustible gas detector, a smoke detector, and a temperature detector.

In a specific embodiment, the intelligent fire monitoring camera can monitor the internal conditions of the energy storage system 10 in real time from the outside.

The intelligent fire monitoring camera is equipped with an intelligent image recognition module, which can identify whether smoke, open flames, or other conditions exist inside the energy storage system 10.

In some embodiments, each fire detection module 202 is set with three levels of warning thresholds, specifically as follows:
Combustible gas detector: Level 1 warning: CO, 50 ppm, H2, 100 ppm; Level 2 warning: CO, 190 ppm, H2, 300 ppm; Level 3 warning: CO, 300 ppm, H2, 1000 ppm;
Temperature detector: Level 1 warning: 60° C.≤detected value<70° C.; Level 2 warning: 70° C.≤detected value<80° C.; Level 3 warning: 80° C.≤detected value;
Smoke detector: Level 1 warning: 2 mg/m³≤detected value<3 mg/m³; Level 2 warning: 3 mg/m³≤detected value<5 mg/m³; Level 3 warning: 5 mg/m³≤detected value;
In some embodiments, the cell temperature and voltage collection have three levels of warning thresholds, specifically as follows:
Cell temperature: Level 1 warning: 45° C.≤detected value<50° C.; Level 2 warning: 50° C.≤detected value<55° C.; Level 3 warning: 55° C.≤detected value;
Cell voltage: High voltage Level 1 warning: 3.5 V≤detected value<3.55 V; Level 2 warning: 3.55 V≤detected value<3.6 V; Level 3 warning: 3.6 V≤detected value; Low voltage Level 1 warning: 2.5 V≤detected value<2.8 V; Level 2 warning: 2.0 V≤detected value<2.5 V; Level 3 warning: detected value<2.0 V;
The warning levels can also be set with different thresholds based on different systems.

In some embodiments, the linkage strategy between the fire protection system 12, the battery temperature and voltage collection system, and the access control system 11 is as follows:
When the fire protection system 12 triggers a Level 1 warning, the fire protection system 12 automatically activates the alarm device to prompt external personnel to evacuate, and the access control system 11 maintains its current state until the alarm is automatically cleared. The system administrator can manually judge whether the detector parameters require activating the fire ventilation or suppression system or switching the access control to an emergency state;
When the fire protection system 12 triggers a Level 2 warning, the fire protection system 12 automatically activates the alarm device to prompt external personnel to evacuate, and the access control system 11 switches to an emergency state. The system administrator can judge through the monitoring system whether an emergency has occurred. If it is determined to be a false trigger by the detector, the external emergency stop button can be manually pressed, and the access control system 11 can return to normal operating mode. If the emergency stop button is not pressed, the access control remains in the emergency state, and the fire protection system 12 performs fire suppression after a certain delay;
When the fire protection system 12 triggers a Level 3 warning, the access control system 11 immediately enters the emergency mode and cannot be switched to other modes through external operations. The fire protection system 12 performs fire suppression after a certain delay. Until the warning is cleared, the system administrator can manually adjust the access control. If it changes to another level of warning, the corresponding linkage strategy for that level is executed.

Based on the same inventive concept, the embodiments of the present application further provide an access control method. In the embodiments of the access control method, the access control module serves as the executing entity. For simplicity and ease of description, the executing entity will be omitted in the subsequent method embodiments. The method includes: acquiring fire protection data sent by the fire protection system and operational data of the energy storage module sent by the battery management system; determining a target access control mode of the access control system based on the fire protection data and the operational data; and determining an access control instruction for the switch control module based on the target access control mode, so as to control the opening and/or closing of the container door through the switch control module based on the access control instruction.

The access control method of the present application is described in detail below with reference to the accompanying drawings. Although the present application provides the method operation steps as shown in the following embodiments or drawings, the method may include more or fewer operation steps based on routine or non-creative efforts. In steps where no necessary causal relationship exists logically, the execution order of these steps is not limited to the execution order provided by the embodiments of the present application. During the actual object processing process or when executed by a device, the method can be executed sequentially or in parallel according to the method order shown in the embodiments or drawings (e.g., in a parallel processor or multi-threaded processing environment).

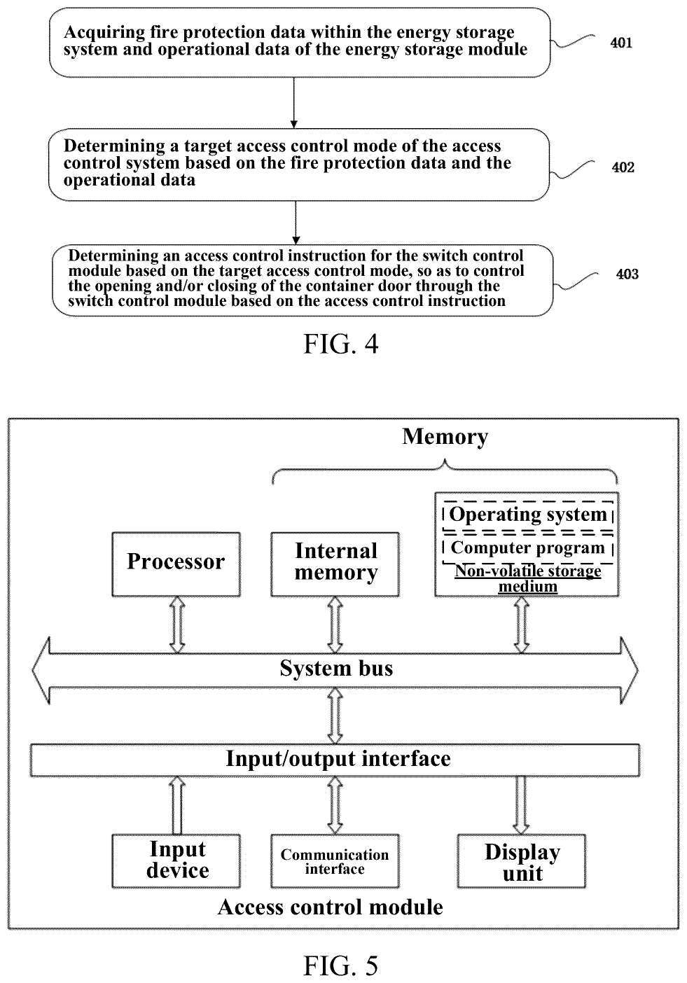

Referring to FIG. 4, the access control method may include the following steps 401 to 403:

Step 401. Acquiring fire protection data within the energy storage system and operational data of the energy storage module.

Acquiring fire protection data within the energy storage system and operational data of the energy storage module may include: acquiring fire protection data sent by the fire protection system and operational data of the energy storage module sent by the battery management system.

Step 402. Determining a target access control mode of the access control system based on the fire protection data and the operational data.

In some embodiments, the access control modes include a non-locked mode and a locked mode, the fire protection data include normal fire protection feedback data and abnormal fire protection feedback data, and the operational data include a normal operating state and a stopped operating state; determining the target access control mode of the access control system based on the fire protection data and the operational data includes: if the fire protection data are normal fire protection feedback data and the operational data indicate a stopped operating state, determining the access control mode as the non-locked mode; if the fire protection data are abnormal fire protection feedback data and/or the operational data indicate a normal operating state, determining the access control mode as the locked mode.

Step 403. Determining an access control instruction for the switch control module based on the target access control mode, so as to control the opening and/or closing of the container door through the switch control module based on the access control instruction.

In the embodiments of the present application, by acquiring fire protection data sent by the fire protection system and operational data of the energy storage module sent by the battery management system, determining a target access control mode of the access control system based on the fire protection data and the operational data, and determining an access control instruction for the switch control module based on the target access control mode, so as to control the opening and/or closing of the container door through the switch control module based on the access control instruction, the access control system can interoperate with the energy storage module and fire protection system of the energy storage system. This allows the access control system to set corresponding access control modes based on the fire protection and operational conditions of the energy storage system, thereby reducing safety risks of the energy storage system and improving safety of the energy storage system.

In some embodiments, the step of determining an access control instruction for the switch control module based on the target access control mode, so as to control the opening and/or closing of the container door through the switch control module based on the access control instruction, may further include: acquiring user identity information; determining a target access permission of the user based on the user identity information and a preset mapping relationship between user identity information and access permissions, and determining an access control instruction for the switch control module based on the target access permission and the target access control mode, so as to control the opening and/or closing of the container door through the switch control module based on the access control instruction.

In some embodiments, the access control system further includes a remote control module, and the remote control module is connected to the access control module; the method further includes: receiving remote control information and sending it to the access control module to remotely control the switch control module.

In some embodiments, the method further includes:

Based on the same inventive concept, the embodiments of the present application further provide an access control module, which may be a server or a terminal apparatus. The access control module includes a memory and a processor, the memory storing a computer program, and the processor executing the computer program to implement the steps of the above access control method. This enables various functions, such as: acquiring fire protection data sent by the fire protection system and operational data of the energy storage module sent by the battery management system; determining a target access control mode of the access control system based on the fire protection data and the operational data; determining an access control instruction for the switch control module based on the target access control mode, so as to control the opening and/or closing of the container door through the switch control module based on the access control instruction.

The access control module provided by the embodiments of the present application acquires fire protection data sent by the fire protection system and operational data of the energy storage module sent by the battery management system through the access control module in the access control system, determines a target access control mode of the access control system based on the fire protection data and the operational data, and determines an access control instruction for the switch control module based on the target access control mode, so as to control the opening and/or closing of the container door through the switch control module based on the access control instruction. This enables the access control system to interoperate with the energy storage module and fire protection system of the energy storage system, allowing the access control system to set corresponding access control modes based on the fire protection and operational conditions of the energy storage system, thereby reducing safety risks of the energy storage system and improving safety of the energy storage system.

The specific implementation of the above operations can be referred to in the previous embodiments and will not be repeated here.

In one embodiment, taking the access control module as a terminal apparatus as an example, an internal structure diagram of the access control module may be as shown in FIG. 5. The access control module includes a processor, a memory, an input/output interface, a communication interface, a display unit, and an input device. The processor, memory, and input/output interface are connected via a system bus, and the communication interface, display unit, and input device are connected to the system bus via the input/output interface. The processor of the access control module is used to provide computing and control capabilities. The memory of the access control module includes a non-volatile storage medium and an internal memory. The non-volatile storage medium stores an operating system and a computer program. The internal memory provides an environment for the operation of the operating system and computer program in the non-volatile storage medium. The input/output interface of the access control module is used for exchanging information between the processor and external apparatuses. The communication interface of the access control module is used for wired or wireless communication with external terminals, and wireless communication can be implemented via wireless fidelity (Wi-Fi), mobile cellular networks, NFC (near field communication), or other technologies. The computer program, when executed by the processor, implements an access control method. The display unit of the access control module is used to form a visually visible image and may be a display screen, a projection device, or a virtual reality imaging device. The display screen may be a liquid crystal display or an e-ink display. The input device of the access control module may be a touch layer covering the display screen, or buttons, a trackball, or a touchpad provided on the housing of the access control module, or an external keyboard, touchpad, or mouse, etc.

Those skilled in the art can understand that the structure shown in FIG. 5 is only a block diagram of a portion of the structure related to the solution of the present application and does not constitute a limitation on the access control module to which the solution of the present application is applied. The specific access control module may include more or fewer components than shown in the figure, or combine certain components, or have a different arrangement of components.

Based on the same inventive concept, the embodiments of the present application further provide a computer-readable storage medium, which may include: read-only memory (ROM), random access memory (RAM), magnetic disk, or optical disk, etc. The computer-readable storage medium may be non-volatile or volatile.

Since the computer program stored in the computer-readable storage medium can execute any access control method provided by the embodiments of the present application, it can achieve the beneficial effects that any access control method provided by the embodiments of the present application can achieve. For details, refer to the previous embodiments, which will not be repeated here.

Based on the same inventive concept, the embodiments of the present application further provide a computer program product or computer program, the computer program product or computer program including computer instructions, and the computer instructions is stored in a computer-readable storage medium. The processor of the access control module reads the computer instructions from the computer-readable storage medium, and the processor executes the computer instructions, causing the access control module to execute the methods provided in various optional implementations of the above embodiments.

Those of ordinary skill in the art can understand that all or part of the processes in the methods of the above embodiments can be implemented by instructing relevant hardware through a computer program. The computer program can be stored in a non-volatile computer-readable storage medium, and when executed, the computer program can include the processes of the embodiments of the above methods.

Any reference to memory, databases, or other media used in the embodiments provided by the present application may include at least one of non-volatile and volatile memory. Non-volatile memory may include read-only memory (ROM), magnetic tape, floppy disk, flash memory, optical memory, high-density embedded non-volatile memory, resistive random access memory (ReRAM), magnetoresistive random access memory (MRAM), ferroelectric random access memory (FRAM), phase change memory (PCM), graphene memory, etc. Volatile memory may include random access memory (RAM) or external cache memory, etc. For illustration and not limitation, RAM can take various forms, such as static random access memory (SRAM) or dynamic random access memory (DRAM), etc.

The databases involved in the embodiments provided by the present application may include at least one of relational databases and non-relational databases. Non-relational databases may include blockchain-based distributed databases, etc., but are not limited thereto. The processors involved in the embodiments provided by the present application may be general-purpose processors, central processing units, graphics processing units, digital signal processors, programmable logic devices, quantum computing-based data processing logic devices, etc., but are not limited thereto.

In the present application, the access control module in the access control system acquires fire protection data within the energy storage system and operational data of the energy storage module, determines a target access control mode of the access control system based on the fire protection data and the operational data, and determines an access control instruction for the switch control module based on the target access control mode, so as to control the opening and/or closing of the container door through the switch control module based on the access control instruction. This enables the access control system to interoperate with the energy storage module and fire protection system of the energy storage system, allowing the access control system to set corresponding access control modes based on the fire protection and operational conditions of the energy storage system, thereby reducing safety risks of the energy storage system and improving safety of the energy storage system.

In the above embodiments of the access control method, device, computer-readable storage medium, access control module, and computer program product, each embodiment has its own focus, and parts not detailed in one embodiment can refer to the related descriptions of other embodiments. Those skilled in the art can clearly understand that, for the convenience and brevity of description, the specific working processes and beneficial effects of the access control method, system, related apparatus, and energy storage system described above can refer to the description of the access control method in the above embodiments, which will not be repeated here.

1. An access control system applied to an energy storage system, the energy storage system comprising a container, a container door disposed on the container, an energy storage module disposed within the container, and the access control system;
wherein the access control system comprises a switch control module and an access control module, and the access control module is connected to the switch control module; and
the access control module is configured to acquire fire protection data within the energy storage system and operational data of the energy storage module, determine a target access control mode of the access control system based on the fire protection data and the operational data, and determine an access control instruction for the switch control module based on the target access control mode, so as to control opening and/or closing of the container door through the switch control module based on the access control instruction.

2. The access control system according to claim 1, wherein the access control system further comprises an identity recognition module, and the identity recognition module is connected to the access control module; and
the identity recognition module is configured to collect and identify user identity information and send the user identity information to the access control module;
the access control module is configured to determine a target access permission of the user based on the user identity information and a preset mapping relationship between user identity information and access permissions, and determine an access control instruction for the switch control module based on the target access permission and the target access control mode, so as to control the opening and/or closing of the container door through the switch control module based on the access control instruction.

3. The access control system according to claim 2, wherein the access control modes comprise a non-locked mode and a locked mode; and
the step of determining the access control instruction for the switch control module based on the target access permission and the target access control mode, so as to control the opening and/or closing of the container door through the switch control module based on the access control instruction, comprises:
if the target access control mode is the non-locked mode and the target access permission meets a preset access permission requirement, generating an access control instruction and sending the access control instruction to the switch control module to control the opening of the container door through the switch control module;
if the target access control mode is the locked mode and user identity information is acquired, generating a non-openable feedback message and sending the non-openable feedback message to a preset target terminal.

4. The access control system according to claim 1, wherein the access control modes comprise a non-locked mode and a locked mode, the fire protection data comprise normal fire protection feedback data and abnormal fire protection feedback data, and the operational data comprise a normal operating state and a stopped operating state;
the step of determining the target access control mode of the access control system based on the fire protection data and the operational data comprises:
if the fire protection data are normal fire protection feedback data and the operational data indicate a stopped operating state, determining the access control mode as the non-locked mode; and
if the fire protection data are abnormal fire protection feedback data and/or the operational data indicate a normal operating state, determining the access control mode as the locked mode.

5. The access control system according to claim 1, wherein the access control system further comprises a remote control module, and the remote control module is connected to the access control module; and
the remote control module is configured to receive remote control information sent by a user terminal and send the remote control information to the access control module to remotely control the switch control module.

6. The access control system according to claim 2, wherein the access control system further comprises a remote control module, and the remote control module is connected to the access control module; and
the remote control module is configured to receive remote control information sent by a user terminal and send the remote control information to the access control module to remotely control the switch control module.

7. The access control system according to claim 3, wherein the access control system further comprises a remote control module, and the remote control module is connected to the access control module; and
the remote control module is configured to receive remote control information sent by a user terminal and send the remote control information to the access control module to remotely control the switch control module.

8. The access control system according to claim 4, wherein the access control system further comprises a remote control module, and the remote control module is connected to the access control module; and
the remote control module is configured to receive remote control information sent by a user terminal and send the remote control information to the access control module to remotely control the switch control module.

9. An energy storage system, wherein the energy storage system comprises a container, a container door disposed on the container, an energy storage module disposed within the container, a battery management system, a fire protection system, and an access control system;
the access control system comprises a switch control module and an access control module, the access control module is connected to the switch control module, the battery management system, and the fire protection system, the switch control module is disposed on the container door, and the battery management system is connected to the energy storage module;
the fire protection system is configured to acquire fire protection data and send the fire protection data to the access control module;
the battery management system is configured to acquire operational data of the energy storage module and send the operational data to the access control module; and
the access control module is configured to determine a target access control mode of the access control system based on the fire protection data and the operational data, and determine an access control instruction for the switch control module based on the target access control mode, so as to control opening and/or closing of the container door through the switch control module based on the access control instruction.

10. The energy storage system according to claim 9, wherein the fire protection system comprises a fire protection control module, a fire detection module, a fire suppression module, and a fire alarm module, and the fire protection control module is connected to the fire detection module, the fire suppression module, the fire alarm module, and the access control module;
the fire detection module is configured to collect fire detection data of the energy storage system and send the fire detection data to the fire protection control module;
the battery management system is further configured to collect battery monitoring data of the energy storage module and send the battery monitoring data to the fire protection control module, the battery monitoring data comprising voltage monitoring data and temperature monitoring data of each cell in the energy storage module; and
the fire protection control module is configured to determine the fire protection data based on the fire detection data and the battery monitoring data, send the fire protection data to the access control module, and control the fire suppression module to execute a corresponding fire suppression strategy based on the fire protection data.

11. The energy storage system according to claim 10, wherein the fire detection module comprises at least one of an intelligent fire monitoring camera, a combustible gas detector, a smoke detector, and a temperature detector.

12. An access control method, wherein an energy storage system comprises a container, a container door disposed on the container, an energy storage module disposed within the container, and an access control system; wherein the access control system comprises a switch control module and an access control module, and the access control module is connected to the switch control module;
the method comprises steps as follows:
acquiring fire protection data within the energy storage system and operational data of the energy storage module;
determining a target access control mode of the access control system based on the fire protection data and the operational data; and
determining an access control instruction for the switch control module based on the target access control mode, so as to control opening and/or closing of the container door through the switch control module based on the access control instruction.

13. A computer-readable storage medium, wherein a computer program is stored thereon, and the computer program is loaded by a processor to execute the steps of the access control method according to claim 12.
